(19) United States
(12) Patent Application Publication
(10) Pub. No.: US 2025/0275649 A1
(43) Pub. Date: Sep. 4, 2025

(54) BBQ VENTING SYSTEM

(71) Applicant: James Mallory Kidd, IV, Birmingham, AL (US)

(72) Inventor: James Mallory Kidd, IV, Birmingham, AL (US)

(21) Appl. No.: 19/066,081

(22) Filed: Feb. 27, 2025

Related U.S. Application Data
(60) Provisional application No. 63/560,668, filed on Mar. 2, 2024.

(51) Int. Cl. A47J 37/07; A23L 5/10; A47J 36/06; F24B 5/06

(52) U.S. Cl. CPC A47J 37/0704; A23L 5/10; A47J 36/06; A47J 37/0763; F24B 5/06

(57) ABSTRACT

A BBQ grill venting system is disclosed that allows for the customization of different cooking zones within a single BBQ cooking grill. The grill includes a plurality of adjustable vents that permit the precise tuning of venting conditions within the heated interior of the grill cooking area under the BBQ lid. The variable vents are arranged in a circumferential pattern around the lower rounded top surface of the BBQ lid so that grouping of controlled temperature zones and internal atmospheric adjustments may be made to the interior of a selected cooking zone from the exterior adjustment of the different venting groups. The adjustments allow for the controlled cooking of different types of meats in different zones on a single cooking grate instance in the BBQ grill.

### FIELD OF THE INVENTION

The present invention relates generally to BBQ air flow configurations systems in a BBQ lid. In particular, the present invention relates to control of heat zones within a BBQ by variable venting in a BBQ lid. In greater particularity, the present invention relates to methods of cooking meat on a BBQ grill by venting combustion gasses to control cooking grate temperature zones.

### BACKGROUND OF THE INVENTION

A Barbecue (typical US usage is “BBQ”) grill is a cooking appliance that uses various fuels to cook meats and vegetables on a cooking grate surface. This type of cooking appliance, often referred to as “BBQ grilling” or simply “grilling,” allows for a form of cooking that involves a dry heat applied to the food, typically from below, using a variety of heating sources, such as charcoal, gas (e.g. propane or natural gas), wood chips, pellets, and often a combination of these sources. Grilling is an effective heating technique in order to cook meat or vegetables, depending upon the food and desired outcome of the cook, because a significant amount of heat can be applied in high proximity to the targeted food. However, grilling is also flexible, allowing for both rapid conventional heating, or slower indirect radiant heating of foods by altering the proximity of the heat in relation to the targeted food and through variation of venting of the utilized various fuel sources.

A standard, stand-alone BBQ grill typically consists of several parts, including a firebox, cooking grate, charcoal grate, lid, and vents. The firebox is in the main body of the grill, where the heating source, such as charcoal, is placed and lit to produce combustion and heat. The cooking grate position above the heating source is the surface on which the food is placed, while the charcoal grate is the surface on which the charcoal is placed just under the cooking grate. The lid is used to cover the grill, trapping heat and smoke to cook the food and add a savory flavor to the targeted food that is distinctive of BBQed foods. Importantly, the vents on the grill lid are used to control the airflow, which in turn controls the temperature of the grill. The resultant concentrated heat allows for the creation of excellent tasting, cooked meats, while locking in the meats juices for a self-basting, internal savory eating experience.

In standard usage, a BBQ grill is first placed on a flat, stable surface, away from any flammable materials and the lid vents opened to allow for proper airflow through and around the firebox area. Charcoal is then placed on the charcoal grate and lit, allowing it to burn until it is covered in white ash. The combustion wait time varies based on the type of fuel utilized in the firebox, but the appearance of white ash exterior on charcoal, such as charcoal briquettes, ensures that the food flavor is untainted by flammable combustion accelerant chemicals, such as lighter fluid, that may be topically applied to the combustion material or which may be embedded on the exterior of the fuel source to facilitate the rapid and easy combustion of the fuel. For example, Match Light® briquettes is a popular brand of charcoal briquette used in grilling and includes a fuel accelerant embedded within the exterior of the briquette to allow for immediate, and effortless lighting of the entire fuel source with a minimum of user firebox tending.

Once the fuel source is prepared and partially combusted, such as when ash covers charcoal exterior, the cooking grate is placed on top of the firebox and targeted food items placed on the grate for cooking. The lid to the grill is then placed over the grate, making sure the vents are open, thereby sealing the targeted food items adjacent to the fuel source and in a partially pressurized atmosphere of combustion byproducts.

BBQ grills typically include two vents that allow for the control of the airflow within the grill and, therefore, the temperature of the grill. One vent is positioned on the underside of the kettle lower bowl portion and another is typically positioned on the upper surface of the kettle lid adjacent to a lid handle. By opening either of these vents, more air is allowed into the grill, which increases the combustion reaction of the fuel source and thereby the temperature within the enclosed, lidded area. By closing the vents, less air is allowed into the grill, which decreases the temperature, but increases the exposure of combustion byproducts, namely, fuel source smoke, to the targeted food. It is important to monitor the temperature of the grill and adjust the vents as needed to ensure the food is cooked to the desired level. Moreover, by varying the venting of the grill a skilled BBQ cook can vary the ratio of smoke byproducts to heat and to impart the exact taste, degree of doneness, and the temperature of the targeted food placed on the cooking grate. Thus, an experienced BBQ grill cook can, especially for meats such as pork and steak, achieve a fully cooked, BBQ flavored piece of meat that has from time immemorial been sought after by BBQ meat consumers.

Positioning of the fuel source within a BBQ grill is also an important consideration to a BBQ cook. For example, a fuel source such as charcoal may be positioned uniformly onto a lower fuel grate within the BBQ or it may be layered to one side of the fuel grate to allow for indirect heating, as will be further described. In addition, modern grills also may include a conical metal accessory, the accessory having open lower and upper ends, that may be position on the lower fuel grate that fully contains the combustion source. The conical accessory may be positioned in a narrow end up, or a narrow end down, depending upon the type of food source to be cooked and the type of cooking strategy to be used, but the accessory is typically positioned in the center of the fuel grate. Some influencers and popular BBQ cooks referred to this accessory as a “Vortex” grill accessory, probably due to the perception that combustion gasses are concentrated into a central shaft of rising heat within the grill kettle.

While vegetables are often cooked on a BBQ grill, especially in a Shish Kebab arrangement, meats are typically targeted for cooking on a BBQ grill. A variety of meats can be cooked on a BBQ grill, including beef, pork, chicken, and fish. Each type of meat requires a different cooking time and temperature, so a cook's experience is an important factor to achieve a good taste and texture to the targeted food. Hence, proper control and precise adjustment of lid vents are needed to ensure the proper preparation of the meat. Beef, for example, can be cooked to various levels of internal temperatures, from rare to well-done, while chicken should always be cooked to an internal temperature of 165° F. to ensure it is safe to eat. Fish, on the other hand, should only be cooked until it flakes easily with a fork, but not overdone such that the smoke flavoring does not overpower the delicate fish flavor.

Therefore, a BBQ grill is a versatile, popular cooking appliance that can be used to cook a variety of meats and vegetables to perfection. While a BBQ grill includes a fairly simple arrangement of grill elements, including a firebox, a firebox vent, a cooking grate, a charcoal or fuel grate, a lid, and a lid vent, the arrangement creates a controlled cooking environment that permits a skilled user to cook a variety of foods and impart a savory and highly sought after BBQ taste to targeted food. The venting on the lid is particularly important, as it allows for the control of the airflow and temperature of the overall grill.

However, typical BBQ grills only include a single vent in the flat, top portion of the lid which only permits control of the entire cooking interior of the grill. This current arrangement forces cooks to often use multiple BBQ grills simultaneously so that the cook may vary the conditions on each grill separately to create a suitable cooking environment for the quantity and type of foods that are being cooked. However, quite often, one grill is sufficiently large to accommodate all of the food that needs to be cooked so that using multiple grills, or grills used in succession, could be avoided if the cooking conditions may be varied in different areas within the single grill. This feature is not available with a BBQ grill that has a single grill vent in the upper surface of the BBQ lid.

Therefore, what is needed is an improved lid venting system that allows for the variable control of the venting gases by a user to create various cooking zones within a single BBQ grill that can accommodate different types of targeted foods within a single grill to assist a cook in the perfection of BBQ food preparation.

### SUMMARY OF THE INVENTION

It is the object of the present invention to provide a variable venting system that is embedded in the lid of a BBQ grill. In particular, the venting system includes a plurality of meshed gears that permits the fine tuning of multiple venting orifices or openings into the heated interior of the grill cooking area under the lid. The variable vents are arranged in a circumferential pattern around the lower circumference of the rounded BBQ lid so that grouping of controlled temperature zones and internal atmospheric adjustments may be made to each cooking zone area via an exterior adjustment of a selected venting group. The vents also permit the promotion of a high volume of air to be exhausted from the BBQ lid thereby causing a greater amount of combustion within the cooking kettle.

Other features and objects and advantages of the present invention will become apparent from a reading of the following description as well as a study of the appended drawings.

### BRIEF DESCRIPTION OF THE DRAWINGS

A meshed gear venting system incorporating the features of the invention is depicted in the attached drawings which form a portion of the disclosure and wherein:

FIG. 1 is a perspective view of a typical BBQ grill;

FIG. 2 is an exploded view of the typical BBQ grill shown in FIG. 1;

FIG. 3 is a top plan view of a typical lid of the BBQ grill shown in FIG. 1 and FIG. 2;

FIG. 4 is a top plan view of an improved BBQ grill lid incorporating an improved lid venting system;

FIGS. 5A-5D show 4 perspective view of a vent used in the improved lid venting system;

FIGS. 6A and 6B shows two perspective views of a vortex accessory used in an inverted and standard fashion;

FIG. 7 is a top perspective view of a BBQ grill in which the fuel source has been sequestered to one side of the fuel source grate;

FIG. 8 is a plan view of the cooking grill element of a BBQ system showing four quadrant, cooking zones controlled by vents arranged within the BBQ cooking vessel lid; and,

FIG. 9 is a perspective diagrammatic view of the heated combustion air flow under the cooking vessel lid.

### DESCRIPTION OF THE PREFERRED EMBODIMENTS

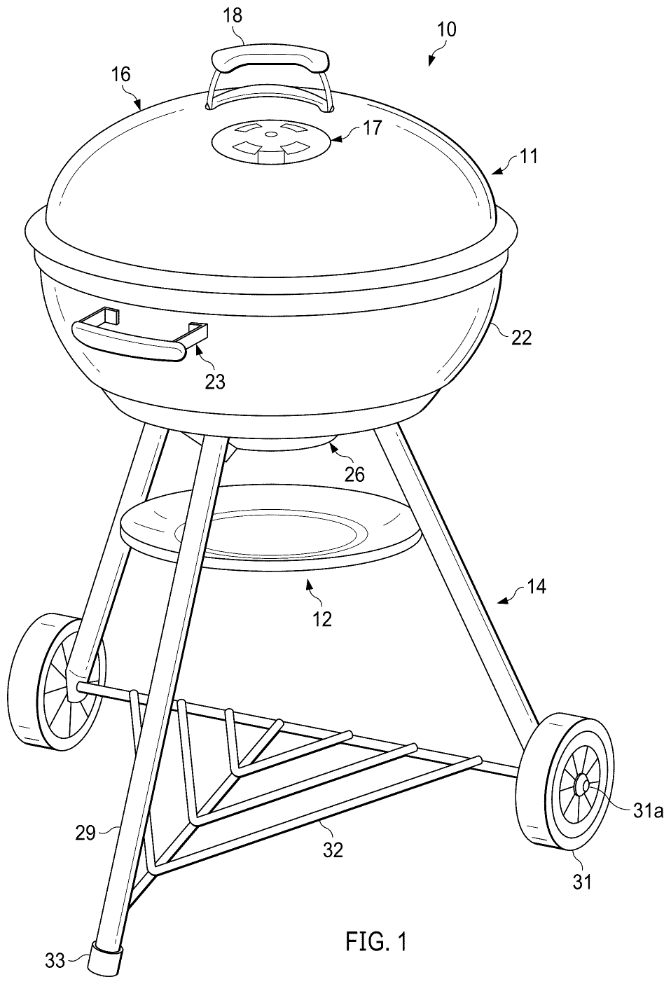

Referring to the drawings for a better understanding of the function and structure of the invention, FIG. 1 shows a typical prior art BBQ grill 10 having typical functional components, such as a cooking kettle 11, an ash catcher 12 and a support stand 14, typically including wheels for easy relocation of the grill 10. All BBQ grills are generate large amounts of heat to lock in the juices on cooked meats, so almost all materials in the grill 10 are made of some type of metal, such as low grade steel and aluminum, that can withstand large amounts of heat.

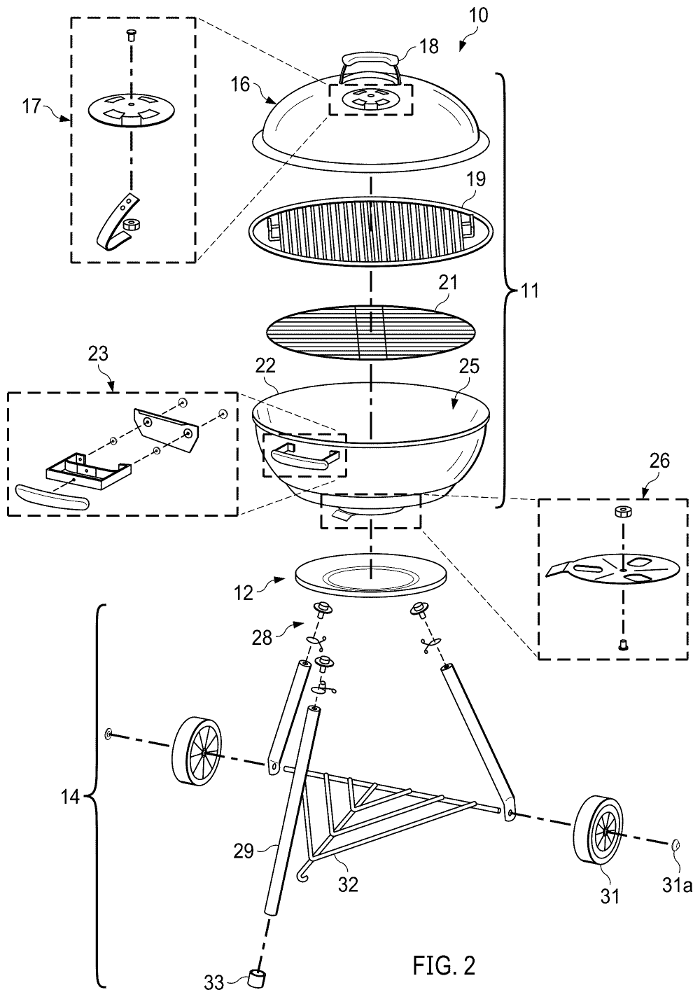

As showing in FIG. 2, typical BBQ grill 10 includes a number of parts that in combination allow for the versatile cooking of any type of food, however BBQ's are best known for the cooking preparation of meats due to the high amount of focused heat that they generate. A kettle section 11 includes a lid 16 that is manipulated by a handle 18 for lifting and rotation thereof. Lid 16 also typically includes a lid damper or variable venting assembly 17 for controlling the exhaustion of combustion gasses and internal temperature of the kettle cooking area. The lid portion 16 is supported by kettle lower bowl portion 22 at its lower circumferential edge. The circumferential edge acts as a seal for the lid and provides a support for a metal cooking grate 19 that is further supported by a series of circumferential support tabs or members (not shown) formed on the inside surface of lower portion 22. Lower portion 22 also includes within its lower interior a combustion chamber or “fire-box” 25 as it is often referred to where combustion materials such as charcoal or wood chips, or a combination thereof are burned. The combustion materials are supported by lower fuel grate 21 that sits within the lower interior of portion 22 but is partially suspended above and spaced from the internal lower surface of the lower portion 22. Lower kettle portion 22 typically also includes a kettle bowl damper 26 that allows for the intake of air for the combustion of fuel materials held by fuel grate 21 to burn, and also for the extraction of fallen ash and combusted materials after a cooking session. The damper 26 typically includes multiple paddles rotatable around a central axis of damper 26 to variably cover and uncover several vent openings formed in the bottom of kettle portion 22, and to agitate ash collected into the bottom of kettle 22 via an integral rotation tab, thereby causing the extraction of that ash onto the ash catcher 12. An ash catcher 12 also helps to support a stand assembly 14 to support the BBQ grill 10, and catch ash debris collected from kettle 11 during combustion. Lower portion 22, and thereby the entire kettle section 11, may be transported via lifting handles 23 that are positioned on the exterior of portion 22 and which include a heat shield to allow for limited movement of kettle 11 without injury, even when the grill is still hot.

As shown, kettle section 11 is supported by stand assembly 14, which typically includes a combination of leg struts 29, leg end caps 33, a wire support assembly 32, wheels 31 and wheel retention bolts 31a, and some connection screws and clamps 28. Stand 14 importantly provides stability for the operation of BBQ and allows for the short-distance transportation of the grill 10 in between grilling operations. As shown, supporting wire assembly 32 connects and supports the kettle 11 between wheels 31 thereby providing important stability to the entire grill.

As is known, ash catcher 12 and lower vent 26 may be integrated into a more complex arrangement to both catch and contain ash debris in an enclosed lower vessel, along with any meat juice and oil that may drip down into the ashes during cooking. Such an arrangement, may also include an extension handle to connect with the paddles of damper and to allow for adjustment of the damper to finely tune the amount of air allowed to enter the combustion area of lower section 22.

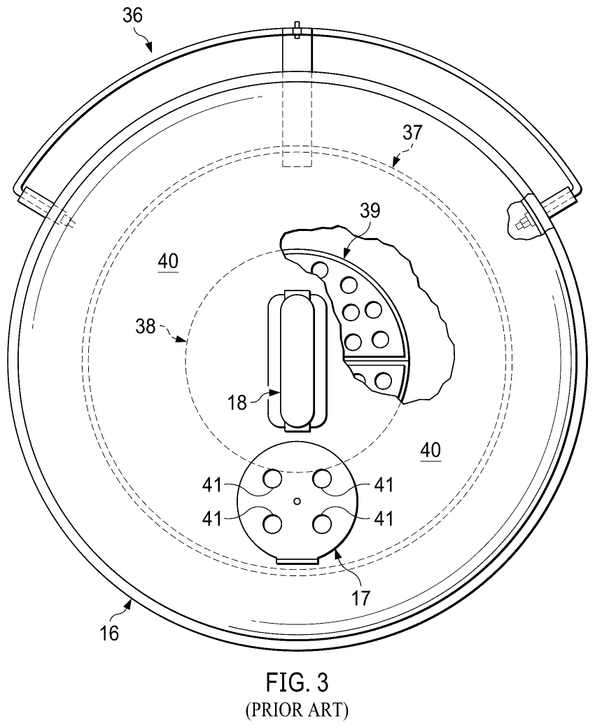

Referring to FIG. 3, lid 16 is typically formed into a curved, hemi-spherical shape, but is usually flattened on its top portion, thereby forming a relatively flat circular margin 40 between concentric circles 37 and 38. Lower kettle portion 22 in some configurations includes an auxiliary side support wire 36 on the exterior of lower portion 22 that allows for the temporary support of the lid 16 so that the lid may be rotated up and temporarily placed on the side of kettle 11 and rotated back selectively for the easy tending of cooking meat within the kettle 11. Handle assembly 18 is supported from and bolted to the inside of lid 16 via a resilient metal mesh 39, and vent 17 is typically located at or within margin 40 as shown. As is known, vent 17 may be adjusted so that one or more apertures 41 may be selectively closed to control the interior combustion reaction in kettle 11 as described above.

Because vent 17 is in a fixed location within portion 40, a grill cook may depending upon the location of combustible fuel held by fuel grate 21 rotate lid 16 to control the temperature in a portion of the cooking grill 19 that is directly beneath vent 17. By rotating the lid, the changing position of the vent 17 somewhat affects the temperature on grill 19 thereby slightly changing the cooking conditions on a portion of the surface of the grill 19. However, this method is inadequate to allow for the proper separation of exhaust gasses at a level that can cook different types of meats on a grill. Hence, even when a typical chef rotates the grill lid 16 in an attempt to adjust heating for a portion of the cooking grill, or simply to ensure that each area is thoroughly cooked, the vent assembly 17 is limited in its ability to meet the requirements of an accomplished BBQ chef, and usually the vent assembly 17 is repeatedly manipulated with the hope that the adjustment will meet the cooking goals, but usually with only limited success.

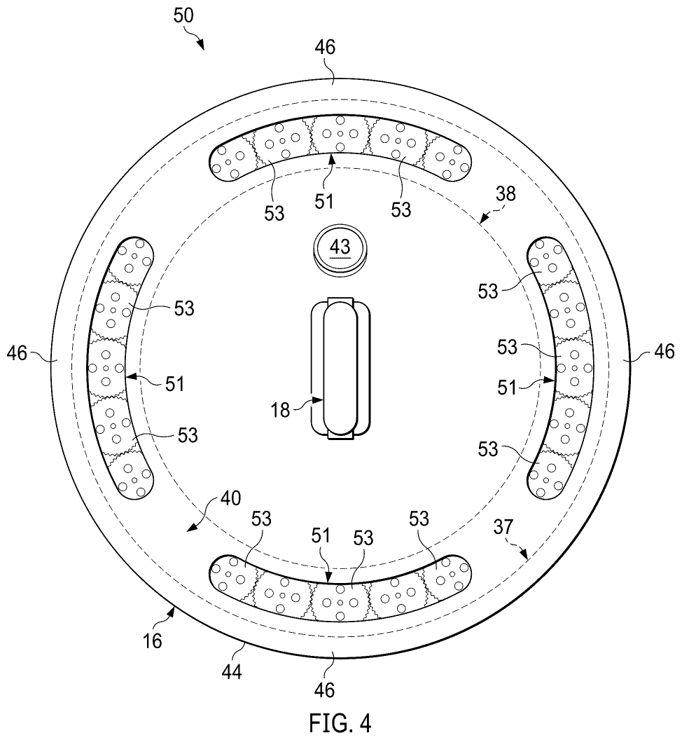

Referring now to FIG. 4, it may be seen that lid 16 is formed to include an improved venting system 50. FIG. 4 shows a modified lid in a plan view with the BBQ grill lower section 22 positioned below lid 16 and not visible. As shown, venting system 50 includes four adjustable vents 51 positioned within a new margin area 40 relocated downward from the flat margin area shown in FIG. 3. Each vent 51 is formed into a spherically contoured shape to match the curvature of the surface of relocated area 40, now bounded by repositioned concentric circle lines 37 and 38. Lid 16 further includes handle assembly 18 and a temperature gauge 43 for measuring temperature within kettle 11.

Each venting zone 51 includes a plurality of venting gears 53, as will be further discussed. However, importantly, vents 51 are positioned on the lower portion of the downward curved surface 46 of lid 16 so that combustion gases held within kettle 11 are allowed to flow forcefully outward and through the vents of the system 50. As discussed in FIG. 3, substantially flat zone 40 upon which vent 17 is formed, only allows for combustion gases to be forced upon and out the zone 40 on the top of the lid 16. Conversely, vents 51 are positioned well below the flat portion 40 so that hot combustion gasses flow around and over any meat or other targeted food material for cooking. Importantly, vents 51 are formed at equal distances around new zone 40 defined by inner and out limits 37, 38. Zone 40 is formed, along the circumferential edge 44 of lid 16 such that vents 51 are positioned approximately 1-2 inches from lower edge 44. As will be discussed, each vent 51 creates four independent cooking zones on the surface of cooking grill 19.

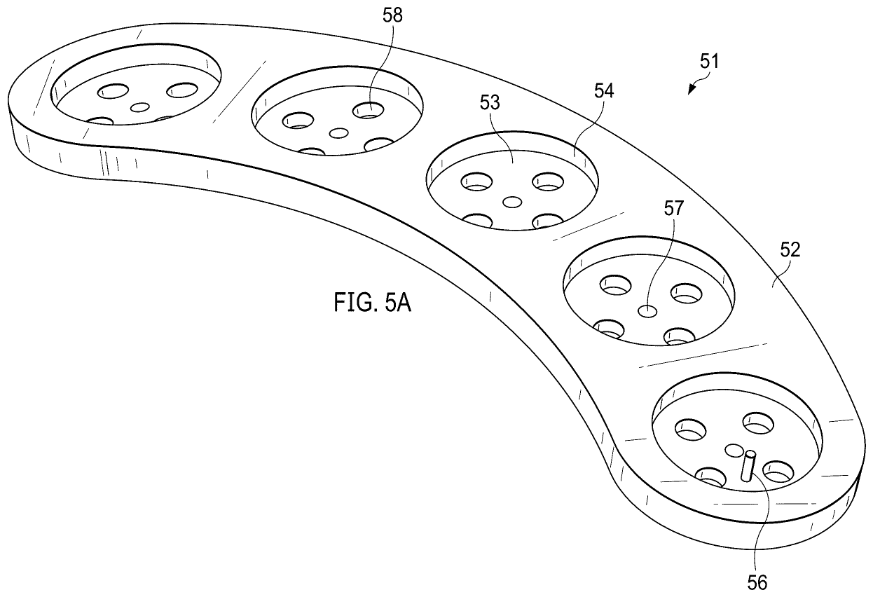

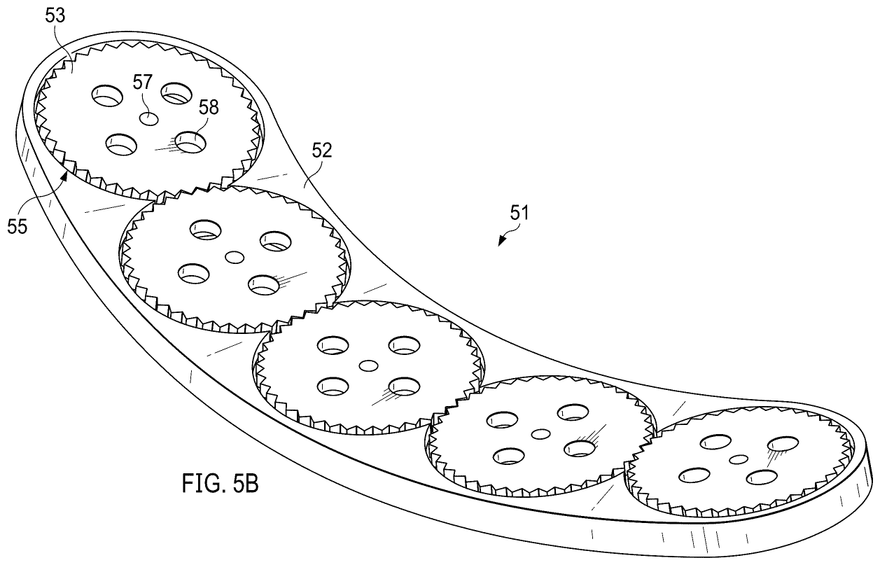

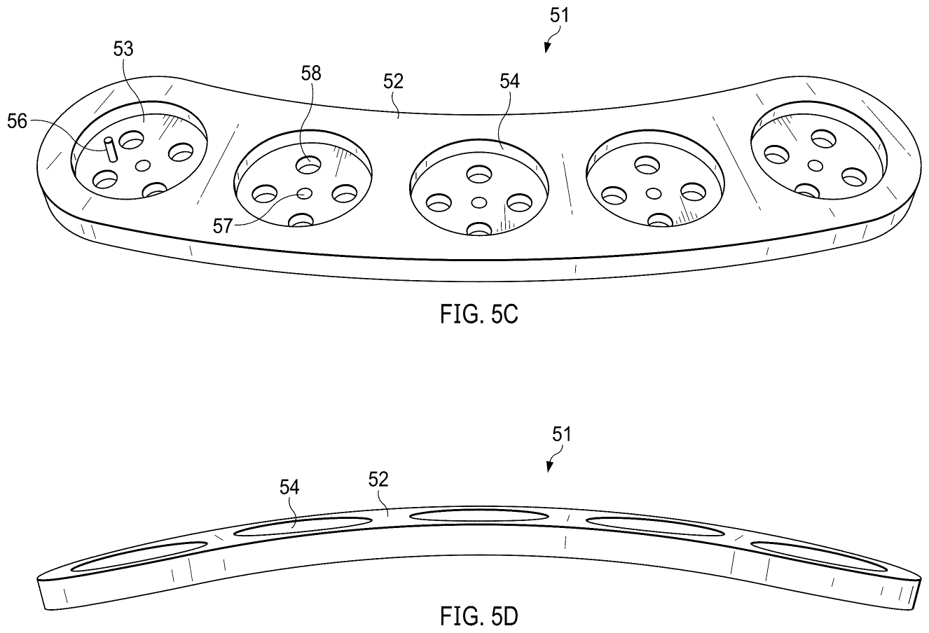

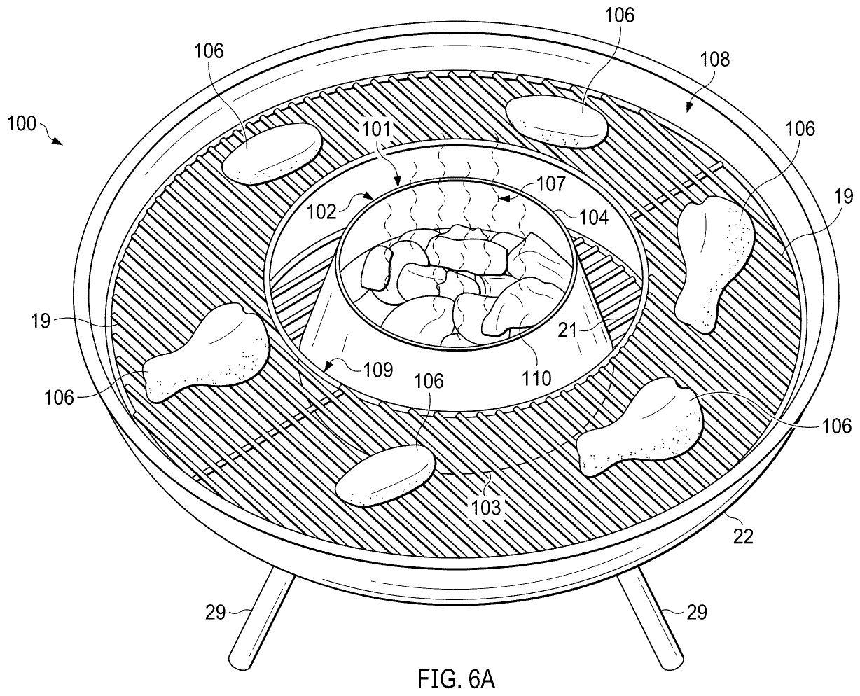

Referring to FIGS. 5A-5D, each vent 51 includes a plurality of venting gears 53 that are supported within an exterior shroud panel 52 with each gear centered within a circular opening 54 formed within shroud 52 on its upper, interior surface thereof. Gears 53 are held in place against the exterior surface of lid 16 with the shroud which is pinned, spot welded, or glued onto the lid surface, as may be understood. Shroud 52 is contoured to create an integrally formed compartment 55 with opening 54 to accommodate each gear 53 such that each gear 53 may freely rotate within the shroud compartment 55 in a floating arrangement biased against the exterior surface of lid 16. The shroud is spaced away from the lid surface such that a small amount of friction is exerted against the upper surface of each gear to slightly squeeze each gear against the exterior surface of lid 16. This arrangement prevents the free-wheeling of gears 53 so that once rotated to a desired rotational position each gear stays at that rotational setting, yet allows for adjustable movement of each gear. To achieve this precise spacing relationship, shroud 52 is preferable curved in three dimensions to follow the curved exterior surface of lid 16 as shown in the figures in order to hold each gear within its own compartment while freely allowing controlled rotation of each gear.

Each venting gear 53 includes a plurality of venting apertures 58 and each gear as described preferably is held within shroud compartment 55 in a floating arrangement. Alternatively, a center screw or pin may retain gear 53 through aperture 57 in lieu of a floating arrangement. Each vent 51 may have its gears 53 rotated via upwardly extending lever 56 located on one of the end gears due to a synchronized, meshed movement relationship. Each gear is meshed with a gear positioned adjacent to another gear as shown so that as the gear with the handle or lever 56 is rotated all gears within the vent 51 are simultaneously rotated. Lid 16 defines a set of lid apertures or holes 61 formed therethrough which are sized and positioned appropriately so that rotation of each gear may variably occlude each holes 61 depending upon the rotation angle of each gear in relation to the lid apertures 61. Notably, apertures 58 are spaced evenly with respect to the circumference of gear 53 so that as each gear is rotated occlusion of each corresponding lid aperture 61 underneath apertures 58 occurs equally and simultaneously for each gear. As shown, each venting gear 53 is positioned to mesh with an adjacently positioned gear so that as one gear is rotated, an adjacently positioned gear is counter-rotated. The apertures 61 in lid 16 are sized and positioned appropriately so that rotation of each gear 53 may fully or partially occlude venting holes 61 depending upon the rotation angle of each gear in relation to the holes in lid 16 irrespective of the rotation direction of each gear 53. When the apertures in venting holes 58 are aligned with apertures 61, combustion gases freely pass through the venting zone 51 and out of the side of lid 16, thereby allowing for a more rapid passage of hot combustion gasses to escape from the open and aligned apertures. Gears 53 may be rotated 360 degrees so that that amount of occlusion may be varied by a user to control airflow through each vent gear 53, and thereby flow through the entire vent 51 as may be understood. The size and availability of holes in each gear 53 are such that the combined effect of each vent 51 is at least a ten-fold increase of air flow out of a single vent, as compared to a standard vent 17, when vent 51 is fully opened.

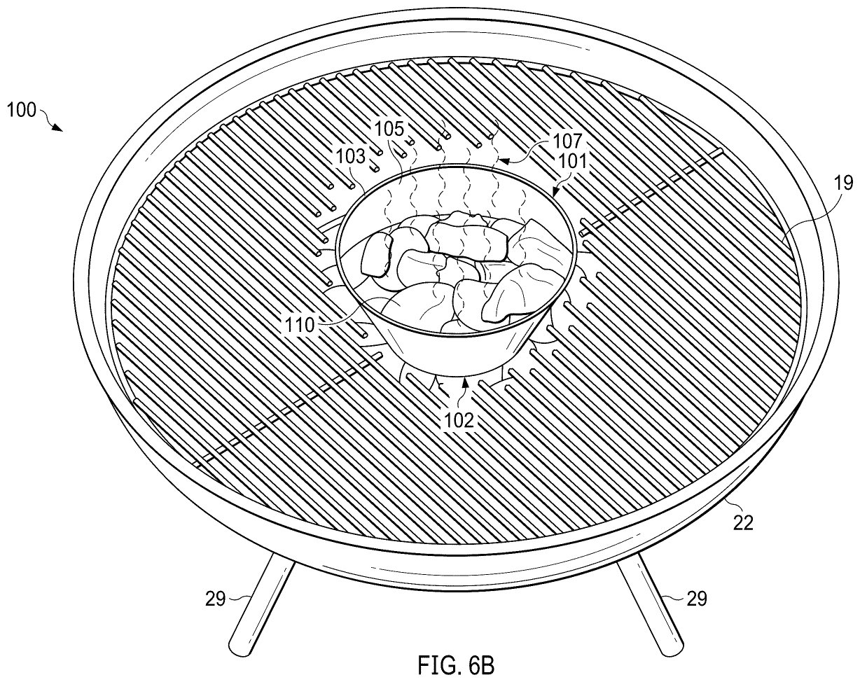

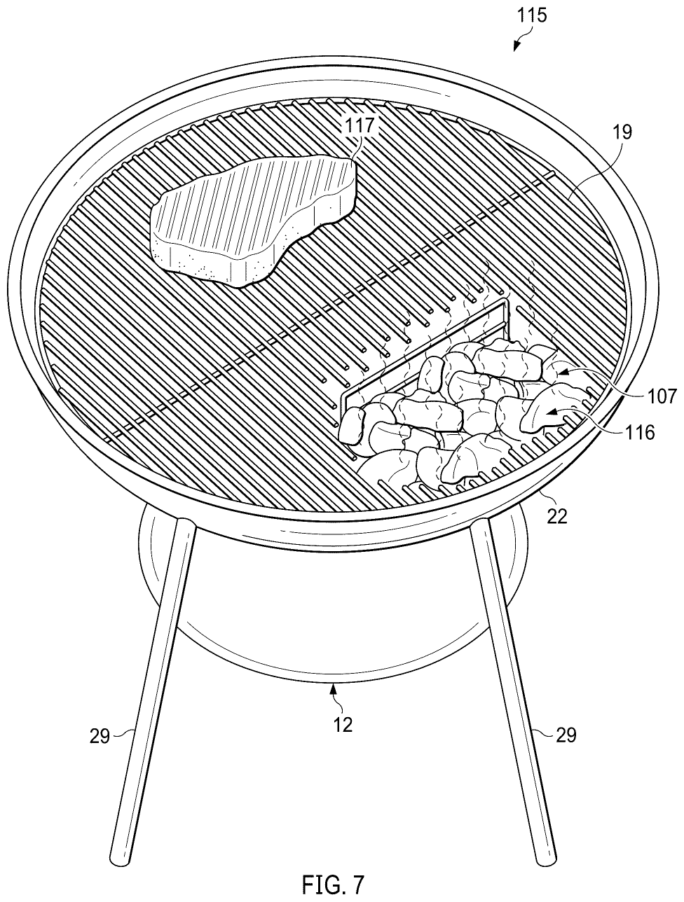

Referring to FIGS. 6A and 6B, it may be seen the use of a cone-shaped, vortex cooking accessory 101. The accessory has large lower end 103 and a smaller, constrained opening end 102, and is made of standard heat resistant metal formed into a conical shape as shown. The accessory is sized to hold a substantial quantity of fuel 110 within its interior and supported by fuel grate 21 such that combustion gases escape through the upper constrained end 102. Due to the shape of the accessory 101, combustion gases are shaped to extend upward vertically concentrating the hot gasses 107 into a vertically shaped shaft. The vortex accessory 101 is used to provide flexibility in how food is cooked on a BBQ grill and such a cooking method is often referred to in the industry as “vortex” cooking 100. Vortex cooking in a BBQ grill is a method that uses the conical accessory 101 to create an indirect heat zone 108 around the accessory but within the grill 10. The accessory 101 is typically, but not always, placed in the center of the grill 10 and filled with lit charcoal 110. Usually, a second accessory (not shown) called a “chimney” is used to hold a quantity of charcoal or other fuel source that is pre-lit and combusted within the chimney until the charcoal is well lit and substantially involved with flame or is red-hot in appearance. The burning coals are then dumped into the vortex accessory 101 so that the grill 10 is ready for cooking. The heat from the charcoal in the vortex 101 is directed upwards and then radiates down around the grill, creating an even, high heat zone 108 surrounding the vortex 101. This is referred to in the industry as “indirect” or “radiant” heating so that food 106, such as a beef steak or chicken wings, are not exposed directly to an open combustion gas positioned directly below the food as is typical in a standard BBQ grill. This type of indirect heating, sometimes also referred to as “low and slow” cooking, produces thoroughly cooked meat with a crispy exterior and is an especially desired method for cooking chicken wings. Often times, the cooking grill 19 is shaped to accommodate a vortex type accessory so that the upper opening 102 is even with or slightly protrudes above the level of the cooking grill surface in a circumscribed area 109 formed by the cooking grill 19.

FIG. 6B showing the same accessory 101, but in an inverted position having the larger end 103 above the smaller constrained end 102. In this configuration, a cooking grill 19 is positioned over the inverted accessory 101 and the targeted food, such as a beef steak, positioned over the larger open end 103. The larger opening 103 in this configuration creates an expanded direct heating exhaust area 105 in which exhaust gases 107 directly heat meat placed on a cooking grate 19 directly over the exhaust area 105. This produces rapid heating of the exterior of the meat 106 to sear the exterior of the meat and lock in juices.

In another application of an inverted vortex accessory 101 depicted in FIG. 6B, a stand sometimes referred in the industry as a “beer can” stand (not shown) is placed at the center of the inverted accessory and a whole chicken is placed over the beer can stand wholly enclosed within the inverted accessory 101. Hot coals, such as created with a chimney as described above, are scattered around the exterior vortex accessory so that chicken is cooked again with indirect heating, but from outside of the larger end 103 of the accessory 101. Such an indirect method of heating is preferred by many BBQ grill chefs because the stand may include various types of cooking ingredients, such as for example beer, that will vaporize and impart desired flavors on the chicken during cooking.

As will be understood, in all arrangements shown in FIGS. 6A and 6B, lid 16 would be placed over the cooking grill 19 to enclose the vessel 11 during cooking. In addition, as may be further understood, the vortex accessory may be positioned underneath cooking grill 19 in various locations to further control the strength of radiant heating or direct heating in one direction or another.

A further indirect method 115 of cooking is shown in FIG. 7. Coals 116 as a fuel source are placed to one side of the fuel grate 21 and a targeted meat 117 is placed on the opposite side of the kettle 11 on the cooking grate 19. Customarily, lid 16 is simply placed over the lower vessel 22 to form a closed vessel 11 during cooking. However, in this cooking method 115 lid 16 is slightly repositioned or displaced in the direction of the targeted meat 117 so that a slight gap is created just to the inside of the upper lip of vessel 22 adjacent to the meat 117. This type of cooking creates a drafting effect such that combustion gasses 107 are drawn toward the meat 117 thereby cooking the meat 117 more quickly and with a seared outside. However, with multiple zones, heat is not contained within cooking kettle 11 as efficiently as with an enclosed lid, and other cooking zones as will be discussed suffer a loss of cooking heat, thereby extending the cooking time of some foods on the grill 19.

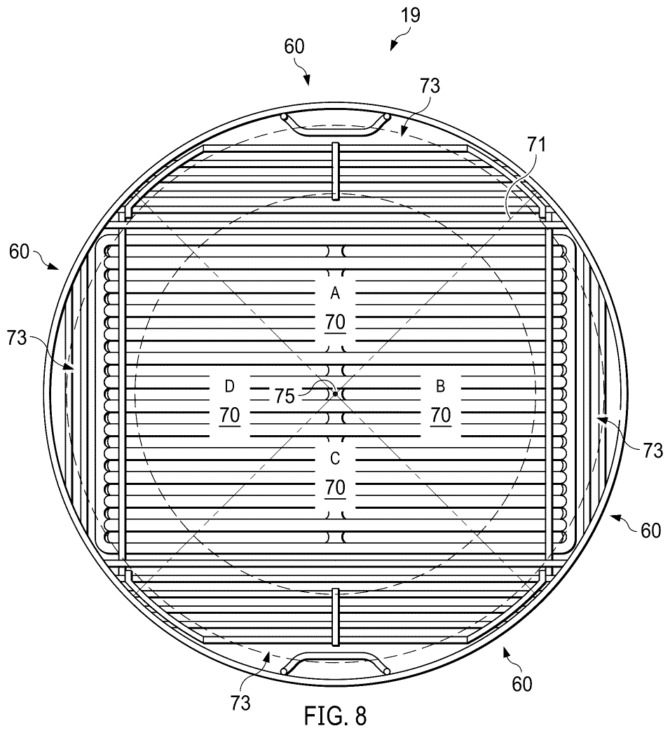

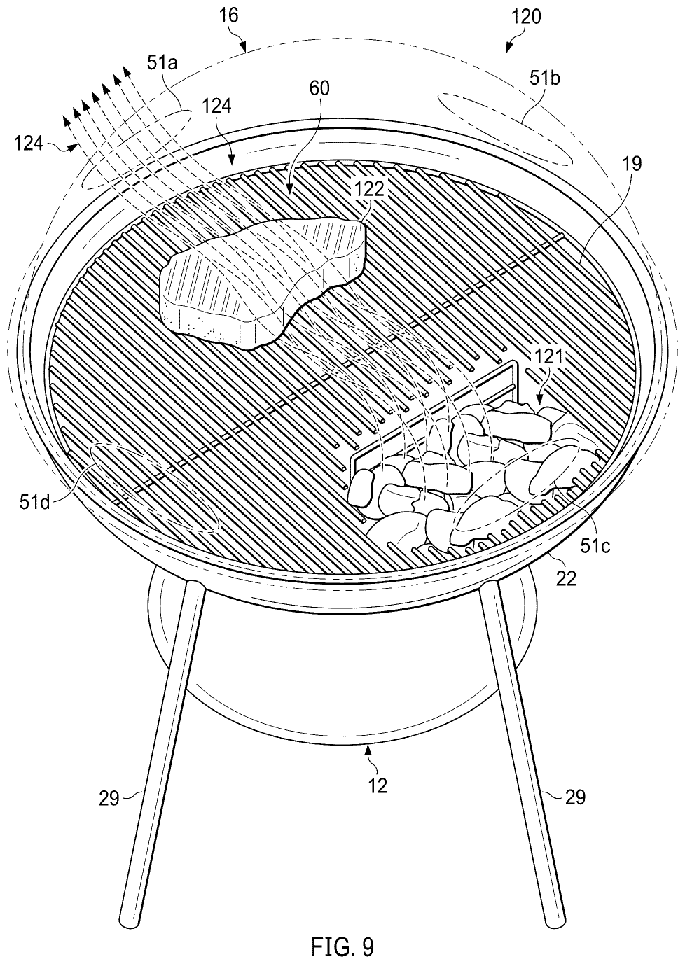

Now referring to FIG. 8, cooking grate 19 is shown with the lower lid zone 40 of FIG. 4 superimposed onto the grate 19 in phantom to form a circular zone 73 that represents the zone into which vents 51 would be positioned. The cooking grate 19 is separated into a plurality of cooking zones 70(A-D) that form, for example, four quadrants of temperature and atmospheric conditions separated along lines 71. Each quadrant 70 includes a single venting zone 60 that together forms an entire venting system 50. The four quadrants A-D intersect at the center 75 of cooking grate 19 and extend outward to the furthest extent of the interior of the kettle 11 under lid 16, providing four separate cooking zones that are adaptable to the type of meat placed in the respective zone. As may be understood, each venting zone may be adjusted independently of any other zone by rotating the venting gears 53 as selectively adjusted by a user via handle or lever 56. Hence, as each zone 60 is adjusted, the temperature and atmospheric conditions in any respective cooking zone 70(A-D) may be altered as needed. This allows for a user (i.e. a grill cook) to sequester different types of foods, such as beef, poultry, vegetables or fish, into specific zones 70 and adjust the venting zone conditions 60 to selectively create a cooking condition (e.g. temperature) that suits the cook's taste preferences for that type of meat. This also allows for the simultaneous cooking of various foods on a single cooking surface within a single kettle 11.

For example, cooking zone 70A may hold beef steaks that the user wishes to heat to the maximum extent possible and expose the beef to a high level of combustion products to thoroughly caramelize the external fat of the meat, thereby adding flavor to the meat per the heating caused by the particular selected combustion materials. For that maximum heating condition, the venting gears may be rotated to allow for a full-flow of combustion gases to flow into zone A, thereby providing extra heat to that particular zone. Conversely, zone C may hold fish and the user may wish to partially or fully close the venting zone above zone C so that combustion in that zone is somewhat retarded, but still allowing for full cooking. Other zones may require partial or fractional closure of its superior vent zone to best suit the food in their respective zones. Hence, by varying each zone vent, a user can vary the cooking conditions in each zone to best suit the food in that zone and cook all foods simultaneously, but within somewhat different atmospheric grilling conditions.

The above described cooking zones A, B, C and D are also desirable in a vortex cooking configuration (see FIGS. 6A-6B) because a smaller proportion of fuel (vs standard cooking fuel distribution) is positioned directly and contained in the center of the grill whereas the food source is then placed around the circumference of the circular fuel source. This setup affords the ability for either extreme or low temperature (without direct convection) for superior results. The vortex may also be moved to the edge of the kettle and used in combination with the current venting system to enhance the vortex cooking effect for a particular zone of directed vortex heating.

Further air dynamics created by the improved venting system 50 are shown in FIG. 9. FIG. 9 shows a sequestered pile of charcoal 121 positioned on fuel grate 21 on a side opposite to a targeted piece of food, such as a steak 122. Vent 51a is positioned adjacent to steak 122 and gears 53 rotated to open vent 51a fully to create a hot cooking zone 60 conducive for a selected condition desired to cook a steak. In operation, as vent 51a is adjusted, air is vented and flows along exhaust airflow path 124 to surround and pass close by meat 122. This occurs with lid 16 fully seated over lower vessel 22 thereby holding the full exhaust heat within cooking vessel 11, thereby cooking and searing meat 122 rapidly, and allowing for other foods in other cooking zones 60 to be efficiently cooked, but forcing a concentrated amount of heat on the steak in zone 60.

While FIG. 9 shows a sequestered arrangement of charcoal, it will be understood that a full bed of coals can similarly be arranged on fuel grate 21 and vents 51 adjusted so that different cooking conditions are created as is depicted in FIG. 9 by varying the degree that each vent 51 is opened. Similarly, a vortex accessory (see FIG. 6A) may be utilized and vents 51 adjusted so that the exhaust cases are directed toward a particular cooking zone. For example, 3 of the 4 cooking zones 60 may be loaded with chicken wings, but a 4th zone loaded with a piece of steak. The vent 51 adjacent to the steak may then be adjusted to draw exhaust gasses from the top of the vortex accessory over and around the steak so that while the chicken wings are cooked with radiant or indirect heat, the steak is cooked with direct exhaust gases to sear the exterior of the steak. Hence, a skilled cook may vary each vent 51 to adjust the cooking conditions of each adjacent cooking zone 60 allowing for the efficient and variable cooking of foods placed on cooking grate 19 with the lid 16 fully enclosing kettle 11.

While I have shown my invention in one form, it will be obvious to those skilled in the art that it is not so limited but is susceptible of various changes and modifications without departing from the spirit thereof.

Having set forth the nature of the invention, what is claimed is:

1. A BBQ venting system, comprising:
a. a BBQ lid seated upon and enclosing a combustion firebox for a BBQ grill, said firebox including an upwardly extending vessel above and surrounding said firebox for cooking food, said vessel supporting a cooking grate in said food cooking area, said lid further having a substantially hemispherical shape, and wherein said lid is seated upon said upwardly extending vessel at an upper edge thereof thereby sealing said food cooking area;
b. at least one vent formed along a lower curved exterior of said lid, wherein said vent is positioned at a level just above and adjacent to said food cooking area and providing egress of hot cooking gases from within said food cooking area;
c. said vent including a plurality of meshed gears positioned adjacent to one another and each gear having a plurality of venting apertures formed therein; and,
d. wherein said lid further includes a plurality of grouped apertures positioned cooperatively under each said gear in said vent such that as each said gear is rotated said apertures on each said vent are rotationally aligned with said lid grouped apertures to permit variable exhaust of combustion gases held within said lid during cooking.

2. The venting system of claim 1, wherein each said vent further comprises a shroud holding a series of said meshed gears biased against said lid while allowing substantially free rotation thereon.

3. The venting system of claim 2, wherein said vent is three-dimensionally contoured to match the hemispherical surface of said lid at a lower portion thereof.

4. The venting system of claim 3, wherein each said vent defines a cooking zone on said cooking crate such that varying said gears controls a cooking condition in said cooking zone.

5. The venting system of claim 4, wherein said venting system comprises four cooking zones under said lid defined by a single vent in said lid for each cooking zone.

6. The venting system of claim 5, wherein said system includes a vortex accessory positioned in said firebox and said at least one vent draws combustion gases from an annular upper area of said vortex accessory over and around food placed on said cooking grate adjacent to said vent.

7. The venting system of claim 5, wherein said venting system includes a vortex accessory in said firebox and a plurality of vents are arranged around the lower periphery of said lid such that indirect heating of the interior of said lid is uniformly maintained thereby obviating the necessity of rotating said lid during cooking.

8. The venting system of claim 1, wherein at least one of said gears includes a lever extending outward from said gear for rotation of said same.

9. The venting system of claim 8, wherein said gears are arranged in counter rotating fashion relative to one another.

10. The venting system of claim 9, wherein said vent is three-dimensionally contoured to match the hemispherical surface of said lid at a lower portion thereof.

11. The venting system of claim 2, wherein said contact point between said lid and said firebox defines a circle, wherein said venting system comprises a plurality of vents wherein said vents are positioned circumferentially with respect to said circular contact point, and wherein said vents are equally spaced from one another and on opposite sides of said circular contact point.

12. The venting system of claim 1, wherein said contact point between said lid and said firebox defines a circle, wherein said venting system comprises a plurality of vents wherein said vents are positioned circumferentially with respect to said circular contact point, and wherein said vents are equally spaced from one another and on opposite sides of said circular contact point.

13. In a BBQ grill having a stand supporting a substantially sealed lower portion, said substantially sealed lower portion forming a fire box portion contained within a lower area of said lower portion, a cooking rack supported by said lower portion for holding food items for cooking, fuel contained within said fire box portion for supplying heat to cook said food items, and a lid supported by said lower sealed portion for sealing fuel caused heat within said BBQ grill, an improved venting system comprising:
a. a plurality of vents arranged around the circumference of said lid at a lower portion thereof adjacent to said lower sealed portion;
b. said lid defining a series of apertures collocated and beneath each said vent;
c. wherein each said vent includes a plurality of meshed gears for causing rotation of all said gears upon the rotation of any one of said gears; and,
d. each said gear defining a plurality of openings aligned with said lid apertures and cooperatively spaced such that rotation of any gear selectively provides a variable passageway to exhaust combustion gases from burning said fuel in said fire box.

14. The venting system of claim 13, wherein each said vent defines a cooking zone on said cooking rack such that varying said gears controls a cooking condition in said cooking zone.

15. The venting system of claim 14, wherein said venting system comprises four cooking zones under said lid defined by a single vent in said lid for each cooking zone.

16. The venting system of claim 15, wherein at least one of said gears includes a lever extending outward from said gear for rotation of said same.

17. The venting system of claim 13, wherein each said vent further comprises a shroud holding said meshed gears biased against said lid while allowing substantially free rotation thereon;

18. The venting system of claim 17, wherein said contact point between said lid and said firebox defines a circle, and wherein said vents are positioned circumferentially with respect to said circular contact point and are equally spaced from one another and on opposite sides of said circular contact point.

19. The venting system of claim 13, wherein said system includes a vortex accessory positioned in said firebox and said vents draw combustion gases from an annular m upper area of said vortex accessory over and around food placed on said cooking rack adjacent to each said vent.

20. A method for improved cooking in a BBQ grill, comprising the steps of:
a. lighting a fuel source within said grill to create combustion gases under a lid sealing said combustion gases within said grill;
b. placing different types of meats in one or more cooking zones on a cooking grate held under said sealing lid within said grill;
c. adjusting vents adjacent to each cooking zone to control the temperature within each said zone;
d. wherein said vent adjusting step comprises the steps of:
i. selectively rotating a plurality of meshed gears to allow hot combustion gases to pass through said lid at said vent location;
ii. wherein said gear rotation step adjusts the amount of gases that pass through said vent dependent upon the degree of rotation selected for said meshed gears; and,
iii. wherein said adjustment step causes combustion gases to flow over and around food supported by said cooking grate positioned adjacent to an adjusted vent.

21. The method of claim 20, wherein said step of placing meats in said one or more cooking zones comprises the step of placing said meats in equally spaced zones around said cooking grate, wherein each cooking zone and said vents are spaced at equal intervals from one another around the exterior of said BBQ grill.

22. The method of claim 21, wherein said step of lighting a fuel source further comprises the step of lighting a fuel source held within a vortex accessory, and wherein said vent adjustment step cause combustion gases exiting said vortex accessory to flow towards a selected adjusted vent.

23. The method of claim 21, wherein said step of lighting a fuel source further comprises the step of lighting a fuel source contained within a vortex accessory placed at the center of said BBQ grill, said improved cooking method further including the step of adjusting each vent such that combustion gases flow equally out of each vent thereby uniformly and indirectly heating the interior of said BBQ grill.
